(19) United States
(12) Patent Application Publication
(10) Pub. No.: US 2019/0107940 A1
(43) Pub. Date: Apr. 11, 2019

(54) MAP-LIKE INTERFACE FOR AN ELECTRONIC DESIGN REPRESENTATION

(71) Applicant: Bluebeam, Inc., Pasadena, CA (US)

(72) Inventors: Toddie Lee WYNNE, IV, Kaufman, TX (US); Benjamin BRINGARDNER, Euless, TX (US); Joseph Lawson WILLIAMS, Addison, TX (US)

(73) Assignee: Bluebeam, Inc.

(21) Appl. No.: 16/197,767

(22) Filed: Nov. 21, 2018

Related U.S. Application Data
(63) Continuation of application No. 14/881,060, filed on Oct. 12, 2015.
(60) Provisional application No. 62/062,850, filed on Oct. 11, 2014.

(51) Int. Cl. G06F 3/0484; G06F 17/50

(52) U.S. Cl. CPC G06F 3/04845; G06F 17/50; G06T 2210/36; G06T 2200/24

(57) ABSTRACT

A system for providing a map-like interface comprises a plurality of sets of image data, each set of image data having associated location and resolution level data, wherein a first set of image data comprises a first associated location and a first resolution level, and a second set of image data comprises the first associated location and a second resolution level. A processor configured to receive the first set of image data and the second set of image data and to generate one or more user controls that allow a user to selectively display the first of image data with some, all or none of the second set of image data.

### RELATED APPLICATIONS

The present application claims priority to U.S. provisional patent application 62/062,850, filed Oct. 11, 2014, which is hereby incorporated by reference for all purposes as if set forth in its entirety.

### TECHNICAL FIELD

The invention relates generally to systems, methods and devices for managing the display and integration of information related to diagrammatic representations.

### BACKGROUND OF THE INVENTION

Systems and methods for accessing design and drawing data are known, but these systems and methods generally fail to provide a user-friendly user interface.

### SUMMARY OF THE INVENTION

A system for providing a map-like interface is provided that includes a plurality of sets of image data, where each set of image data has associated location and resolution level data, such as where a first set of image data includes a first associated location such as a building and a first resolution level such as 10 meters per inch. A second set of image data includes the first associated location and a second resolution level, such as 1 meter per inch. A processor is configured to receive the first set of image data and the second set of image data and to generate one or more user controls that allow a user to selectively display the first set of image data with some, all or none of the second set of image data, such as a zoom control that allows the user to zoom in from a 10 meter per inch resolution to a 1 meter per inch resolution, or to zoom out from the 1 meter per inch resolution to the 10 meter per inch resolution.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing project controls, in accordance with an exemplary embodiment of the present disclosure;

FIG. 2 is a diagram of a system for providing diagrammatic data, in accordance with an exemplary embodiment of the present disclosure;

FIG. 3 is a diagram of a system for providing navigation controls, in accordance with an exemplary embodiment of the present disclosure;

FIG. 4 is a diagram of a user interface, in accordance with an exemplary embodiment of the present disclosure;

FIG. 5 is a diagram of an algorithm for providing zoom detail control, in accordance with an exemplary embodiment of the present disclosure; and

FIG. 6 is a diagram of an algorithm for providing movement acceleration speed control, in accordance with an exemplary embodiment of the present disclosure.

FIG. 7 is a diagram of an algorithm for changing a level, in accordance with an exemplary embodiment of the present disclosure;

FIGS. 8A and 8B are a diagram of an algorithm for data organization, in accordance with an exemplary embodiment of the present disclosure;

FIG. 9 is a diagram of a system for displaying a drawing with a single view or multiple views, in accordance with an exemplary embodiment of the present disclosure; and

FIG. 10 is a diagram of a system for providing project data storage archive, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Systems for displaying and integrating the data associated with design projects—including but not limited to commercial, residential, and municipal construction, aircraft design, ship design, pipelines, bridges and roadways—are dependent upon paper, primarily because effective user-interface tools are not available in electronic format. As a result, large paper drawings are often required to provide all of the details that might be needed, as well as various separate systems, such as HVAC, electric, plumbing, drywall, foundation, roofing, and framing. While some efforts at digitization have been attempted, they are merely digitized versions of traditional paper drawings sets. Thus, their utility is quite limited, and due to the display size of laptops and tablet computing devices, the use of such drawings is often less utilitarian than the traditional paper drawings that those devices are intended to replace. To address this previously unrecognized problem, the present disclosure provides systems, methods, and devices that intuitively assist a user of design drawings and the underlying data to find the data they are looking for in a manner and format unlike prior art systems.

Unless explicitly stated otherwise, conjunctive words (such as “or”, “and”, “including”, or “comprising” for example) should be interpreted in the inclusive, not the exclusive, sense.

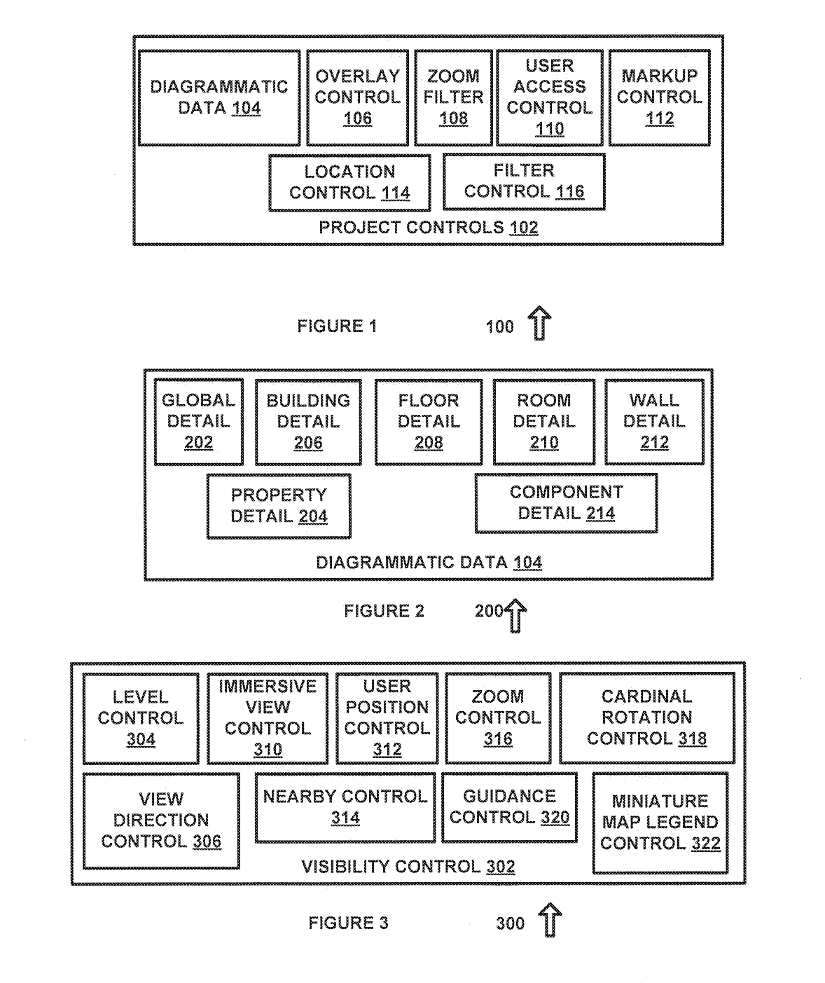

FIG. 1 is a diagram of a system 100 for providing project drawing controls, in accordance with an exemplary embodiment of the present disclosure. System 100 includes project controls 102 and diagrammatic data 104, overlay control 106, zoom filter 108, user access control 110, markup control 112, location control 114 and filter control 116, each of which can be implemented in hardware or a suitable combination of hardware and software.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate soft ware applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device) other suitable connections, or a suitable combination of such connections.

Project controls 102 are configured to provide user interface controls, drawing creation and access controls, drawing and data access controls and other suitable controls for coordinating drawings for a design project. In one exemplary embodiment, project controls 102 can include an application that is used to allow a personal computer, tablet computer, a smartphone or other suitable devices to connect to a cloud-based backend and to generate user interface controls to allow a user to access, create and modify drawings and other project-related design data. In this exemplary embodiment, the application can support offline capabilities, can synchronize changes automatically when the user is online (such as through HTML 5, WebDAV or other suitable protocols), and can perform other suitable functions. Project controls 102 can provide a web-based interface for desktop users that has full functionality and commits changes immediately to the database and backend.

Project controls 102 can be used in conjunction with a cloud-based backend that stores the file content in distributed cloud storage environment, and that allows the user to synchronize with local file stores for population of the cloud and retention of files at the conclusion of a project. The cloud based backend can be accessible from any suitable access point with an Internet connection. Users can access their project through a custom domain on group servers, can host their data in their own local cloud, or can use other suitable systems and processes, depending on data security requirements.

Diagrammatic data 104 allocates electronic drawing data and other project-related data into predetermined categories, to facilitate generation of relevant electronic drawing detail. In one exemplary embodiment, electronic drawing data such as text, lines, symbols, images or other suitable data, is allocated to one of a plurality of classes, where each class corresponds to data that is always present on the electronic drawings, or data that is only present on the electronic drawings at a predetermined level of detail, based on a predetermined overlay control, a predetermined user access control, a predetermined markup control or other suitable data. In this exemplary embodiment, a user can control the data that is shown on an electronic drawing as needed, to facilitate access to relevant data without it being obscured by data that is not presently of interest to the user. Data can likewise be associated with multiple classes, where suitable.

Overlay control 106 generates a plurality of user-selectable overlay controls for use in modifying an electronic drawing. In one exemplary embodiment, overlay control 106 can be implemented as a plurality of objects, each having state and associated graphical, text and functional characteristics. For example, a first object can include a pull-out menu object that allows a user to “pull out” a menu that contains additional overlay control objects. Each additional overlay control object can include a state control, which toggles electronic drawing data associated with the overlay control object on or off, so that it is either visible or not visible to the user. In this manner, a user can generate desired electronic drawing details that are relevant to a current project or time.

Zoom filter 108 allows a user to increase or decrease a level of detail for an electronic drawing, such as to zoom in from a more abstract level to a more specific level, to zoom out from a more specific level to a more abstract level, or to otherwise change detail levels. In one exemplary embodiment, as a user increases or decreases a scale of the electronic drawing, details can be added or removed from the electronic drawing as a function of an associated class. In this manner, the electronic drawing data is maintained at a level that is clean and readable. Information at all zoom levels can also or alternatively be updated as a function of user navigation with panning or toggling disciplines. In one exemplary embodiment, zoom filter 108 can be implemented using a pinch to zoom function in a touch screen user interface, where a user, can utilize a single finger slide action, a two finger pinch action or other suitable touch screen interface controls to pan the view of the drawing.

User access control 110 allows access controls to be selected for data or classes of data. In one exemplary embodiment, a user can be provided with access to electronic drawing data as a function of the user's trade class (e.g. electrician, plumber, mason and so forth), management level, employment status, security clearance, type of data (requests for information, submittals, punch lists, and so forth) or other suitable parameters. In this exemplary embodiment, a user can have multiple permissions assigned, each item or class of items can have multiple associated classes or other suitable processes can be used to allow users to have access to required data.

Markup control 112 generates one or more controls for marking up drawings, for saving drawings markups and for granting permissions to access drawing markups. In one exemplary embodiment, a user can access a writing tool, a comment tool, a stylus tool, a drawing edit tool or other suitable tools, and can assign permissions for markups based on a session, for specific markups or in other suitable manners, where permissions can be granted to individual users, classes of users, can be associated with user access control classes or can be assigned in other suitable manners.

Location control 114 generates one or more controls for finding a location, for identifying location for performing location-related functions, where each control can be implemented as one or more objects that each have state and associated graphical, functional and textual attributes. In one exemplary embodiment, a user can access a control on a graphic interface and can request the user's current location data (such as based on GPS location data, network address data, or other suitable data) be shown on a map. In another exemplary embodiment, a user can use location data to activate data that is shown on a user interface, map or in other suitable manners.

Filter control 116 generates one or more controls for performing filtering functions, where each control can be implemented as one or more objects that each have state and associated graphical, functional and textual attributes. In one exemplary embodiment, filter control 116 can generate a graphic user interface that allows a user to select a filter, to set filter characteristics for image data shown on the screen and associated data for the items included in the image data, to modify the data shown on the display in response to selected filters, and to perform other suitable filter controls.

In operation, system 100 allows a user to access electronic drawing data for a design project in a manner that facilitates access, by classifying the data in a manner that facilitates controllable access to relevant data. System 100 allows a user to dynamically select the type and level of detail of data that is of greatest interest and most utility to the user.

FIG. 2 is a diagram of a system 200 for providing project drawing data, in accordance with an exemplary embodiment of the present disclosure. System 200 includes project drawings data 104 and global detail 202, property detail 204, building detail 206, floor detail 208, room detail 210, wall detail 212 and component detail 214, each of which can be implemented in hardware or a suitable combination of hardware and software.

Global detail 202 can be implemented as an electronic drawing data classification or in other suitable manners, for electronic drawing detail at the highest level, such as the full extent of the portfolio of drawing data for a project. In one exemplary embodiment, multiple projects can be shown at this level, where each project has an associated icon and a fly-out tag that presents basic project information for that project when the project icon is selected. Global detail 202 can also include associated drawing scale range data, such as for drawing scales of greater than one hundred meters per inch or other suitable ranges, where the data classified as global detail level of data can be flagged for generation in an electronic drawing when the drawing scale is in the associated range.

Property detail 204 can be implemented as an electronic drawing data classification or in other suitable manners, for electronic drawing detail at the site level, including but not limited to a site plan for a project. The site plan data can also or alternatively include basic site plan information, such as road layout data, road construction data, drainage and groundwater flow data, site boundary data, graphical data that depicts buildings or projects on the site, associated textual data and other suitable data. Property detail 204 can also include associated drawing scale range data, such as for drawing scales between ten and one hundred meters per inch or other suitable ranges, where the data classified as site detail level of data can be flagged for generation in an electronic drawing when the drawing scale is in the associated range.

Building detail 206 can be implemented as an electronic drawing data classification or in other suitable manners, for electronic drawing detail at a building level of detail, with associated building information such as building names, building area names, building drawing details, building exterior view detail, building access points, building utility service facilities and other suitable building level detail. Building detail 206 can also include associated drawing scale range data, such as for drawing scales between one and ten meters per inch or other suitable ranges, where the data classified as building detail level of data can be flagged for generation in an electronic drawing when the drawing scale is in the associated range.

Floor detail 208 can be implemented as an electronic drawing data classification or in other suitable manners, for electronic drawing detail at a floor level of detail, with associated floor information such as room names, room numbers, column lines and grid bubbles, furniture, fixtures and equipment, tags for other related views such as elevations or linked 3D details) and other suitable floor level detail. Floor detail 208 can also include associated drawing scale range data, such as for drawing scales between one and ten meters per inch or other suitable ranges, where the data classified as floor detail level of data can be flagged for generation in an electronic drawing when the drawing scale is in the associated range.

Room detail 210 can be implemented as an electronic drawing data classification or in other suitable manners, for electronic drawing detail at a floor level of detail, with associated floor information such as such as door tags, equipment tags, wall type tags, door type tags, window type tags, furniture, fixtures and equipment, wall structure, wall finish, corner detail construction requirements, millwork and other plan based finish details, tags for other related views and other suitable floor level detail. Room detail 210 can also include associated drawing scale range data, such as for drawing scales between 0.1 and 1 meters per inch or other suitable ranges, where the data classified as room detail level of data can be flagged for generation in an electronic drawing when the drawing scale is in the associated range.

Wall detail 212 can be implemented as an electronic drawing data classification or in other suitable manners, for electronic drawing detail with icons for wall elements and features. In one exemplary embodiment, wall detail 212 can be separately tracked and visualized or in other suitable manners. In another exemplary embodiment, wall data can be toggled on or off by a user to show color coded location tags indicating the type of work and components, or in other suitable manners.

Component detail 214 can be implemented as an electronic drawing data classification or in other suitable manners, for electronic drawing detail at a component level of detail, with associated component information. Component detail 214 can also include associated attribute data.

In operation, system 200 allows electronic drawing data to be categorized to facilitate access to the electronic drawing by a user at a job site, for planning of construction activities or in other suitable manners. System 200 allows project designs to be categorized by detail level.

FIG. 3 is a diagram of a system 300 for providing navigation controls, in accordance with an exemplary embodiment of the present disclosure. System 300 includes visibility control 302 and level control 304, view direction control 306, immersive view control 310, user position control 312, nearby control 314, zoom control 316, cardinal rotation control 318, guidance control 320 and miniature map legend control 322, each of which can be implemented in hardware or a suitable combination of hardware and software.

Visibility control 302 can be implemented as a plurality of objects, each having state and associated graphical, text and functional characteristics. For example, a first object can represent level control 304, a second control can represent immersive view control 310 and so forth. The objects can be included in a menu object that allows a user to open a menu that contains the additional control objects, the objects can be distributed in one or more user interfaces or can be implemented in other suitable manners.

Visibility control 302 can also include one or more of the following controls:
Search—graphic user interface control that can be implemented as an object having text, graphical and functional attributes, that allows a user to search through one or more sets of project data, such as active electronic drawings, requests for information, previous electronic design drawings, electronic shop drawings, submittals, punch lists, progress photos, laser scans, building information models (BIM), meeting minutes, communications, data in project data sources such as rooms, equipment tags, and so forth) and can present the results dynamically such as while the search is conducted, where each letter filters and/or refines the search results appearing under the search bar, or in other suitable manners. Once a search is completed, the user can select an item from the results, and that item can be shown on electronic drawings if it has a location. The user can select the item to view more specific information, such as the detail of an RFI or punch list item. Types of information can be indicated in results with a leading icon.
Data Repository—graphic user interface control that can be implemented as an object having text, graphical and functional attributes, that allows a user to store and access project data that can be searched. The data repository can be implemented as a layer on top of other database driven systems, can plug into the other database driven systems using an application programming interface or in other suitable manners, to access the data directly or replicate the data into a neutral centralized repository. The data can be normalized as it is replicated in order to assure proper alignment with other data, such as to include additional fields to act as hooks for locating or displaying information about the data. The data repository can be indexed, so that the contents of documents can be accessible to search and tag.
Translate control—graphic user interface control that can be implemented as an object having text, graphical and functional attributes, that allows a user to select a language for all project information.
User Analytics—graphic user interface control that can be implemented as an object having text, graphical and functional attributes, that allows a user to track user patterns, to enable predictive search and advanced project diagnostics and analytics, including but not limited to requests for information, drawings or punch list items that are accessed most frequently in a selected time frame, user statistics (such as which users are using the system, frequency or use, lengths of usage, common usage patterns), user history (such as tracking documents or data that the user has read).
Saved views/set of views—graphic user interface control that can be implemented as an object having text, graphical and functional attributes, that allows a user to save a view with all of the current settings (such as zoom level, position, overlays toggled on, markups) for future reviewing.
Share view—graphic user interface control that can be implemented as an object having text, graphical and functional attributes, that allows a user to share saved views/sets of views with other users via a messaging function.
View Comments—graphic user interface control that can be implemented as an object having text, graphical and functional attributes, that allows a user to activate a social network-style comment tracker that facilitates team collaboration around a saved/shared view or set of views.

Level control 304 can be implemented as a plurality of objects, each having state and associated graphical, text and functional characteristics. In one exemplary embodiment, when a user changes a vertical level such as by activating an up or down button, or a horizontal position within a given level such as by pressing a left/right/forward/reverse button, the speed of movement can accelerate as a function of how long the button is pushed. The movement can be accompanied by an indication of what level or location is currently being flashed as the user moves upward/downward, forward/reverse or left/right.

View direction control 306 wan be implemented as plurality of objects, each having state and associated graphical, text and functional characteristics. In one exemplary embodiment, when a user selects an elevation view control from a plan view, the view can transition from the plan view to the elevation view using a suitable animation, such as where the elevation tilts up and the floor plan fades away, and where a “return to plan” icon is generated while in the elevation view that reverses the animation, when activated. In one exemplary embodiment, the transition can be generated starting from the current location within an electronic drawing and by electronically transitioning to the elevation view. View direction control 306 can also include reflected ceiling plan data and an associated control that allows a user to toggle to a reflected ceiling plan mode, where the electronic drawing shows the reflected ceiling plan information portrayed with information appropriate to the users current zoom level.

Immersive view control 310 can be implemented as a plurality of objects, each having state and associated graphical, text and functional characteristics. In one exemplary embodiment, the user can select a relocatable icon object and can drag and drop it into the electronic building drawings in a selected room, where one or more electronic panoramic room drawings, electronic room renderings, electronic room photos, electronic room laser scans, electronic Building Information Models (BIM) or other suitable data is generated for the selected room. In this exemplary embodiment, the panoramic view can include detail information for the design of the room in lieu of interior elevations, the progress of design or construction activities, such as progress photos, or other suitable data. A control can be generated to allow a user to return to back to a plan view, elevation view or other suitable views. Immersive view control 310 can also include a 3-D details graphic user interface control that can be implemented as an object having text, graphical and functional attributes, that allows a user to activate 3-D details that can be highlighted at the appropriate zoom level. When a user selects the 3-D detail control, dynamic and annotated electronic drawing data is generated for detail in 3-D.

User position control 312 can be implemented as a plurality of objects, each having state and associated graphical, text and functional characteristics. In one exemplary embodiment, the user can activate a graphical control displayed on the electronic drawings and the drawing view can be manipulated by the processor to move to the location of the user within the drawing and to indicate it with a symbol. In another exemplary embodiment, the view can rotate with the user and follows the user, such as when they move through a building or drive around a project. The user location data can be generated using a suitable data source, such as GPS data, WiFi data, iBeacon data, mesh network data, a user can scan a suitable code associated with a location, a location can also be selected from a list of rooms, or location data can be obtained in other suitable manners.

Nearby control 314 can be implemented as a plurality of objects, each having state and associated graphical, text and functional characteristics. In one exemplary embodiment, the user can activate the control to view all project information in the area to which the user is located in, to where the electronic drawing is presently zoomed in, or in other suitable manners. In this exemplary embodiment, the user can obtain location tags for all project information types that are in the user's immediate area or in the area of an associated icon that has been located on the electronic drawing, such as requests for information, submittals, punch lists, job hazard data or other suitable information. The range for the “nearby” class of data can be selected as a function Of zoom level (e.g. within a project for global detail, within a building for site detail, within a room for building detail, and so forth), or based on a user-selected proximity, such as 10 feet, 100 feet and so forth. The information can be displayed using a suitable display mechanism, such as a text list, text balloons, highlighted icons or other suitable mechanisms.

Zoom control 316 generates one or more controls performing zoom functions, where each control can be implemented as one or more objects that each have state and associated graphical, functional and textual attributes. In one exemplary embodiment, zoom control 316 can generate a graphic user interface that allows a user to select a zoom level, to set zoom characteristics for image data shown on the screen and associated data for the items included in the image data, to modify the data shown on the display in response to selected zoom levels, and to perform other suitable zoom functions.

Cardinal rotation control 318 generates one or more controls for performing cardinal rotation functions, where each control can be implemented as one or more objects that each have state and associated graphical, functional and textual attributes. In one exemplary embodiment, cardinal rotation control 316 can generate a graphic user interface that allows a user to select a cardinal rotation amount, to set cardinal rotation characteristics for image data shown on the screen and associated data for the items included in the image data, to modify the data shown on the display in response to a selected cardinal rotation, and to perform other suitable cardinal rotation functions.

Guidance control 320 generates one or more controls for performing guidance functions, where each control can be implemented as one or more objects that each have state and associated graphical, functional and textual attributes. In one exemplary embodiment, guidance control 320 can generate a graphic user interface that allows a user to select guidance, to set guidance characteristics for image data shown on the screen and associated data for the items included in the image data, to modify the data shown on the display in response to selected guidance, and to perform other suitable guidance functions.

Miniature map legend control 322 generates one or more controls for performing miniature map legend functions, where each control can be implemented as one or more objects that each have state and associated graphical, functional and textual attributes. In one exemplary embodiment, miniature map legend control 322 can generate a graphic user interface that allow a user to select a miniature map legend, to set miniature map legend characteristics for image data shown on the screen and associated data for the items included in the image data, to modify the data shown on the display in response to a selected miniature map legend, and to perform other suitable miniature map legend functions.

In operation, system 300 provides electronic drawing access controls that facilitate use of electronic drawings for design projects. System 300 includes drawing access and location-based controls that allow a user to readily find pertinent information in an electronic drawing for use with design activities.

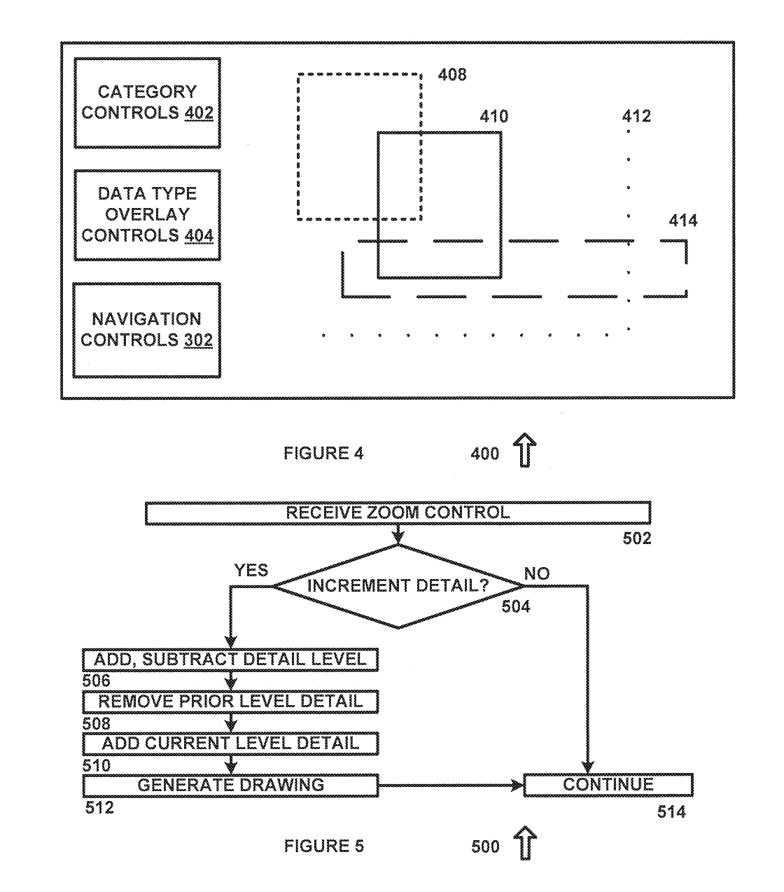

FIG. 4 is a diagram of a user interface 400, in accordance with an exemplary embodiment of the present disclosure. User interface 430 can be implemented using algorithms, one or more objects in a graphic display, such as a touch screen interface of a tablet computer, or in other suitable manners.

User interface 400 includes category overlay controls 402, data type overlay controls 404 and navigation controls 302, each of which can be implemented as one or more objects, each having state and associated graphical, text and functional attributes. In one exemplary embodiment, category overlay controls 402, data type overlay controls 404 and navigation controls 302 can be activated by interfacing with a touch screen interface of a tablet computer, from a menu of controls, or in other suitable manners.

Category overlay controls 402 can include one or more overlay controls for each of one or more associated categories, such as architectural, electrical, plumbing, HVAC (heating, ventilation and air conditioning), structural, security, fire protection, civil or other suitable disciplines, where each category has agreed upon or well-understood responsibilities or tasks. Each category overlay control 402 can have an associated toggle switch for changing the state of the electronic drawing display elements associated With that category from on to off, such as to show or hide architectural features, electrical raceway and equipment, plumbing lines and drains, HVAC equipment and ducts, structural support columns, security monitors and wiring, fire protection pipes and sensors, roadway and water drainage or other suitable features. In this exemplary embodiment, only those overlays of interest to a user at a given time can be activated, so as to reduce the amount on unwanted data shown in an electronic drawing.

Data type overlay controls 404 can include one or more overlay controls for each of one or more associated data types, such as project information, requests for information, punch lists, markups, job hazard data and other suitable data. Each data type overlay control 404 can have an associated toggle switch for changing the state of the electronic drawing display elements associated with that data type from on to off, such as to show or hide requests for information, punch list action items, notes or comments made by the user or by other users, safety incidents or other suitable data. In this exemplary embodiment, only those data overlays of interest to a user at a given time can be activated, so as to reduce the amount on unwanted data shown in an electronic drawing.

Navigation controls 302 can be implemented as one or more objects, each having state and associated graphical, text and functional attributes, such as for providing level/forward/reverse/right/left movement and acceleration, animated tilt to elevation, room view control, locate me control, nearby control or other suitable controls. Drawing access controls can be located in a single predetermined location or distributed around user interface 400, can be activated at predetermined times or constantly available, and can other suitable display and activation functional attributes.

Exemplary hidden and visible drawings components are shown as solid line 410, short dashed line 408, dotted line 412 and long dashed line 414, which each represent different electronic drawing components, such as an electrical component for solid line 410, an architectural component for short dashed line 408, a plumbing component for dotted line 412 and a security component for long dashed line 414. In this exemplary embodiment, only the electrical component associated with solid line 410 would be displayed in the electronic drawing and have an associated discipline overlay control in the on state, but one or more of the discipline overlay controls for the architectural component for short dashed line 408, the plumbing component for dotted line 412 or the security component for long dashed line 414 could be changed from the off state to the on state to change the line from hidden to visible, to adjust color and opacity and to perform other suitable adjustments.

FIG. 5 is a diagram of an algorithm 500 for providing zoom detail control, in accordance with an exemplary embodiment of the present disclosure. Algorithm 500 can be implemented in hardware or a suitable combination of hardware and software.

Algorithm 500 begins at 502, where a zoom control is received. In one exemplary embodiment, a user interface device can generate data that is stored in a register, and a system can monitor the register for data that indicates that the drawing scale associated with a current electronic drawing view should be increased or decreased. The algorithm then proceeds to 504.

At 504, it is determined whether an increment in detail level is required. In one exemplary embodiment, when a change does not exceed a predetermined threshold, no change in detail level may be required. If no change in detail level is required, the algorithm proceeds to 514, otherwise the algorithm proceeds to 506.

At 506, detail levels are added or subtracted, depending on whether the drawing scale has been decreased or increased, respectively. For example, if the drawing scale has been decreased, than finer details will need to be shown, and the detail levels are added. Likewise, when the drawing scale has been increased, then finer details will need to be removed. In either case, the details associated with the electronic drawing at the requisite level of detail are tagged for inclusion in the electronic drawing. The algorithm then proceeds to 508.

At 508, prior level details are removed, such as by turning those details off in the electronic drawing. The algorithm then proceeds to 510.

At 510, the current level details are added to the electronic drawing, such as by turning those details on in the electronic drawing display. The algorithm then proceeds to 512.

At 512, the drawing is regenerated with the current detail level, such as by generating solid lines, text, symbols or other drawing elements in a user display.

In operation, algorithm 500 allows a user to zoom into or tut of an electronic drawing and to have associated details added to or deleted from the drawings at relevant locations. Although algorithm 500 is shown as a flow chart, it can also or alternatively be implemented as an object oriented program, as a state diagram, or using other suitable programming paradigms.

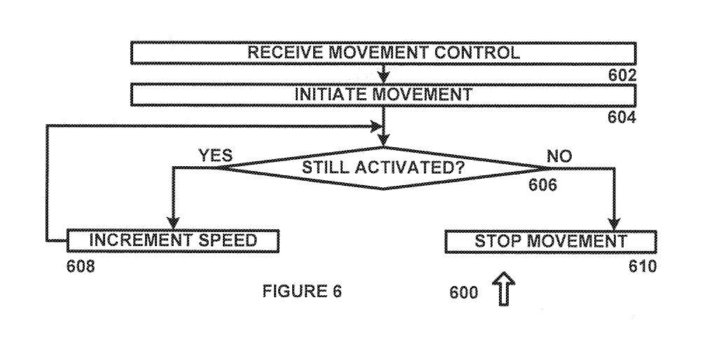

FIG. 6 is a diagram of an algorithm 600 for providing movement acceleration speed control, in accordance with an exemplary embodiment of the present disclosure. Algorithm 600 can be implemented in hardware or a suitable combination of hardware and software.

Algorithm 600 begins at 602, where a movement control is received. In one exemplary embodiment, a movement control can have an associated data register, and the data register can be monitored to determine whether a value has been stored that indicates that movement in an up or down direction, left or right direction, front or back direction or other suitable directions has been received. The algorithm then proceeds to 604.

At 604, movement is initiated. In one exemplary embodiment, an animated movement graphic can be generated that shows a point of view of a user moving up or down through levels, moving right or left along a street or hallway, moving forward or backwards down a street or hallway, or in other suitable manners. The algorithm then proceeds to 606.

At 606, it is determined whether the movement control is still activated, such as by checking the status of the data register or in other suitable manners. If the movement control is not still activated, then the algorithm proceeds to 610 and movement is stopped. Otherwise, the algorithm proceeds to 608.

At 608, a speed of movement is incremented to represent acceleration. In one exemplary embodiment, the speed of movement can be implemented by generating a sequence of frames of image data in a faster succession. In another exemplary embodiment, the speed of movement can be implemented by omitting frames of image data, so as to result in less detail but faster movement. Other suitable processes can also or alternatively be used. Likewise, suitable indicia can be generated to aid the user in determining whether the movement has progressed to a desired point, such as by showing floor level for elevation, house numbers for travel down a street, room numbers for travel down a hall, or other suitable indicia. The algorithm then returns to 606.

In operation, algorithm 600 allows a user to move through a large project from a point of view display in an accelerated manner. Although algorithm 600 is shown as a flow chart, it can also or alternatively be implemented as an object oriented program, as a state diagram, or using other suitable programming paradigms.

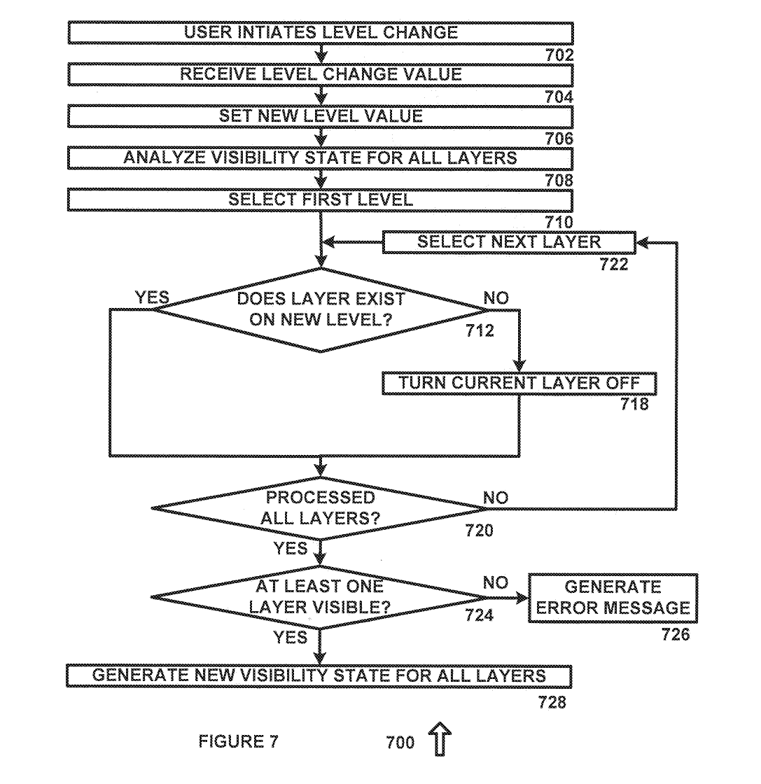

FIG. 7 is a diagram of an algorithm 700 for changing a level, in accordance with an exemplary embodiment of the present, disclosure. Algorithm 700 can be implemented in hardware or a suitable combination of hardware and software. Algorithm 700 allows a user to manipulate the view state of layers shown in the graphical user interface, based on the assigned level value or other suitable data.

Algorithm 700 begins at 702, where a user initiates a level change. In one exemplary embodiment, the user can activate a user interface control that is generated in response to a user interface algorithm that allows the user to select a level, input a number of levels to change, or to perform other suitable processes. The algorithm then proceeds to 704.

At 704, a level change value is received, such as by reading an input data value, by determining a level selection from a user interface control or in other suitable manners. The algorithm then proceeds to 706.

At 706, a new level value is set, such as by processing the selected or entered level value, by combining the current level with an added level change amount, or in other suitable manners. The algorithm then proceed to 708, where a visibility state for all layers analyzed, such as by determining the value of a visibility state variable, by iteratively analyzing each layer, or in other suitable manners. The algorithm then proceeds to 710 where a first level is selected, and the algorithm proceeds to 712.

At 712, it is determined whether a layer exists on the new level. In one exemplary embodiment, a user can select layer for display, can change the state of a layer display control or can perform other suitable processes. If it is determined that a layer does not exist at the new level, the algorithm proceeds to 718 where the current layer is turned off, otherwise the algorithm proceeds to 720.

At 720, it is determine whether all layers of been processed. If all layers have not been processed, the algorithm proceeds to 722, where a new layer selected, and the algorithm then returns to 712. Otherwise, the algorithm proceeds to 724 where it is determined whether at least one layer is visible. If at least one layer is not visible, the algorithm proceeds to 726 and an error message was generated, otherwise the algorithm proceeds to 728 where a new visibility state is generated for all layers and the map is regenerated in the graphic user interface.

In operation, algorithm 700 allows a user to change a level. Although algorithm 700 is shown as a flow chart, it can also or alternatively be implemented as an object oriented program, as a state diagram, or using other suitable programming paradigms.

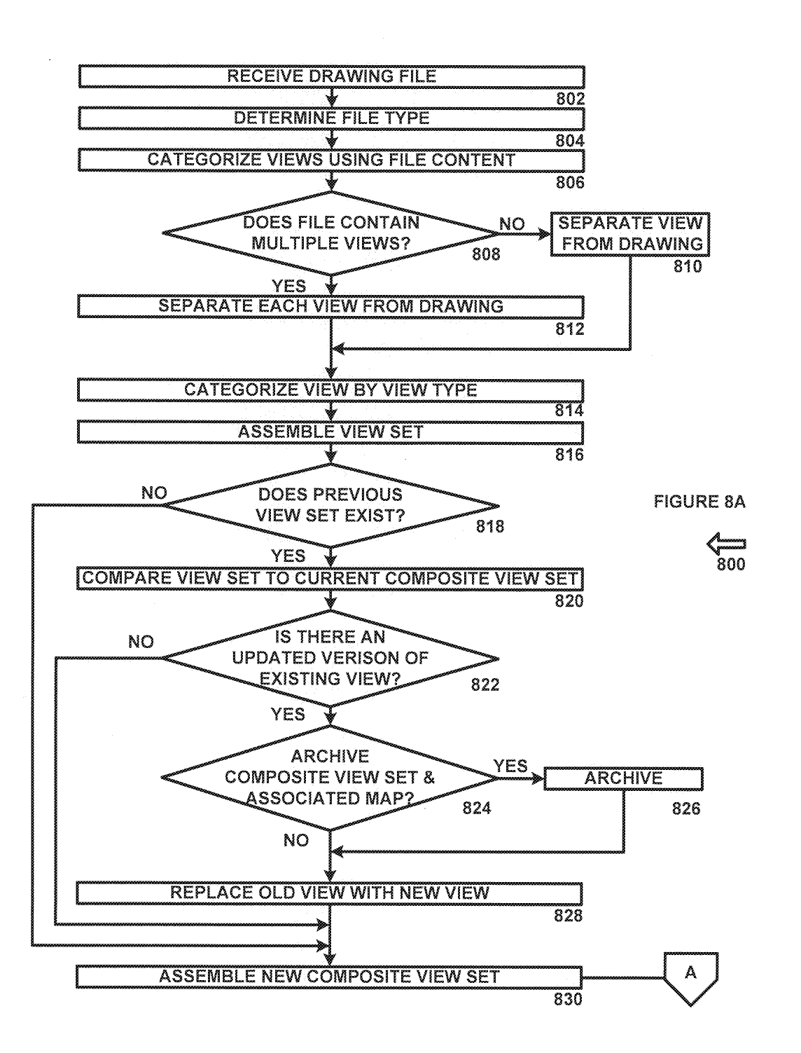

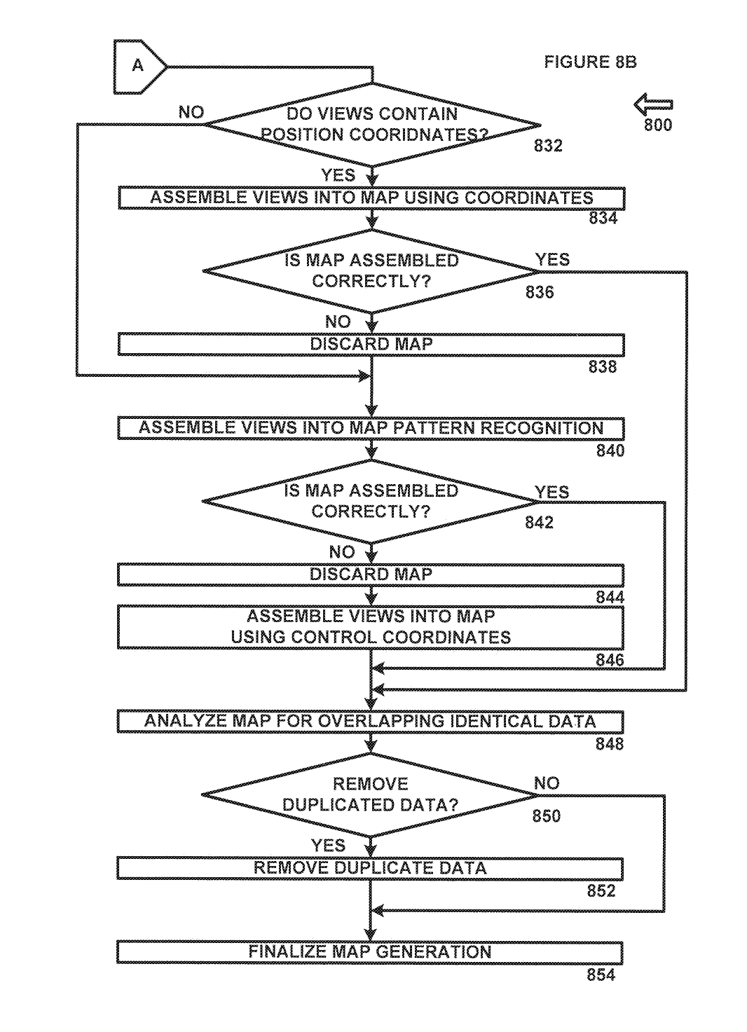

FIGS. 8A and 8B are a diagram of an algorithm 800 for data organization, in accordance with an exemplary embodiment of the present disclosure. Algorithm 800 can be implemented in hardware or a suitable combination of hardware and software. Algorithm 800 can be used to process incoming data files, such as by categorizing each file and combining each file into a final map layer for display in the user interface.

Algorithm 800 begins at 802 where a drawing file is received. In one exemplary embodiment, a file upload process can be used and the user can be prompted to select a drawing file. In another exemplary embodiment, a data import algorithm or control can be used that includes a graphic user interface control that can be implemented as an object having text, graphical and functional attributes, and that allows a user to load data from either an electronic drawing modeling system, documents or in other suitable manners. The algorithm then proceeds to 804 where the file type is determined, such as by reading an extension on the file or in other suitable manners. The algorithm then proceeds to 806.

At 806, views are categorized using file content. In one exemplary embodiment, file content can include data types teat are associated with views, data objects that are associated with views, data architectures that are associated with views or other suitable data. The algorithm then proceeds to 808.

At 808, it is determined whether the file contains multiple views. If it is determined that the file does not contain multiple views, the algorithm proceeds to 810 where the view is separated from the drawing, and the algorithm proceeds to 814. At 812, each view is separated from the drawing, such as by generating associated files, saving the view data to a cache or in other suitable manners. The algorithm then proceeds to 814.

At 814, each view categorized by a view type. The algorithm then proceeds to 816, where a view set is assembled The algorithm then proceeds to 818.

At 818, it is determined whether a previous view set exists. If not, then the algorithm proceeds to 830, otherwise the algorithm proceeds to 820 where the view set is compared to a current composite view set. The algorithm then proceeds to 822.

At 822, it is determine whether there is an updated version of an existing view. If an updated version of an existing view does not exist, the algorithm proceeds to 830, otherwise the algorithm proceeds to 824, where it is determined whether to archive the composite view set and an associated map. If archiving is to be performed, the algorithm proceeds to 826 where the archiving is performed, otherwise the algorithm proceeds to 828 where the old view is replace the new view, and the algorithm proceeds to 830.

At 830, a new composite you said is assembled, and the algorithm proceeds to 832, where it is determined whether the views contain position coordinates. If the view does not contain position coordinates, the algorithm proceeds to 840, otherwise the algorithm proceeds to 834 where the views are assembled into a map using the coordinates. The algorithm then proceeds to 836.

At 836, it is determined whether a map is been assembled correctly. If so, the algorithm proceeds to 848, otherwise the algorithm proceeds to 838 where the map is discarded, and the algorithm proceeds to 840.

At 840, the views are assembled into a map pattern recognition. The algorithm then proceeds to 842, where it is determined whether the map has been correctly assembled. If the map has been correctly assembled, the algorithm proceeds to 848, otherwise the algorithm proceeds to 844 where the map is discarded. The algorithm then proceeds to 846 where the views are assembled into a map using control coordinates. The algorithm then proceeds to 848.

At 848, the map is analyzed for overlapping identical data, and the algorithm proceeds to 850, where it is determined whether duplicate date should be removed. If duplicate data is not removed, the algorithm proceeds to 854, otherwise the algorithm proceeds to 852 where the duplicate data is removed. The algorithm then proceeds to 854, where the map generation is finalized.

In operation, algorithm 800 allows a user to organize data. Although algorithm 800 is shown as a flow chart, it can also or alternatively be implemented as an object oriented program, as a state diagram, or using other suitable programming paradigms.

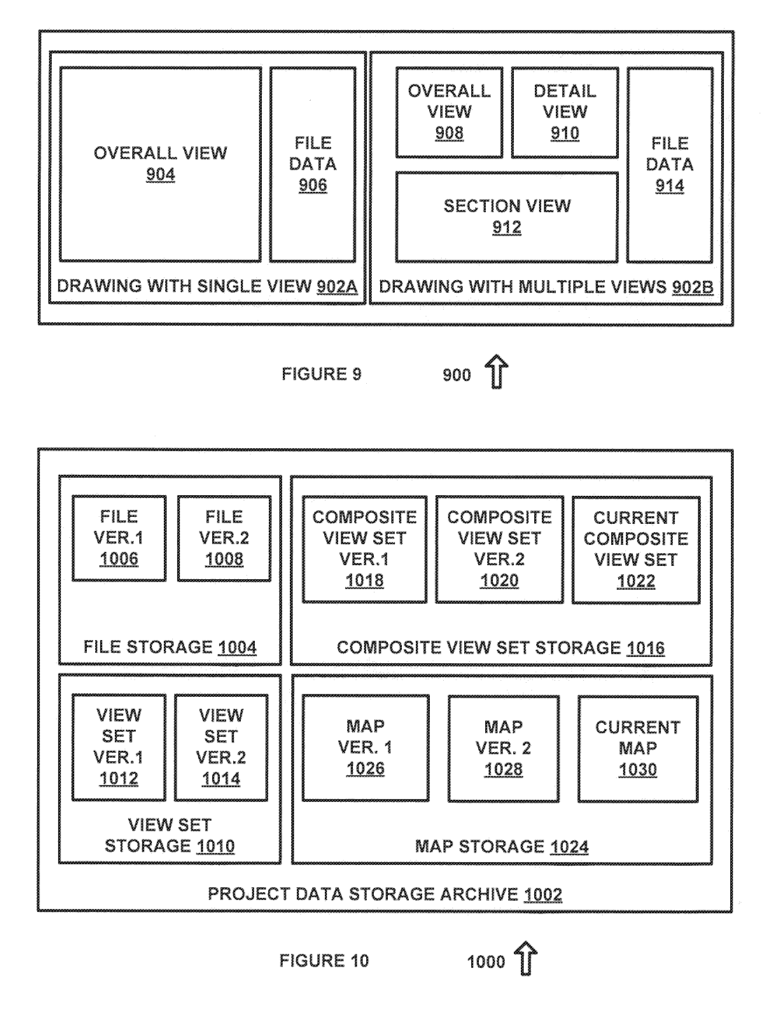

FIG. 9 is a diagram of a system 900 for displaying a drawing with a single view or multiple views, in accordance with an exemplary embodiment of the present disclosure. System 900 includes a drawing with a single view 902A, which includes overall view 904 and file data 906, which can include graphical data, text data, meta data or other suitable data. System 900 also includes a drawing with multiple views 902B, which includes overall view 908, detail view 910, section view 912 and file data 914.

FIG. 10 is a diagram of a system 1000 for providing project data storage archive, in accordance with an exemplary embodiment of the present disclosure. System 1000 includes file storage 1004, which includes file version 1 1006 and file version 2 1008. System 1000 also includes view set storage 1010, which includes view set version 1 and view set version 2 1014.

System 1000 further includes composite view set storage 1016, which includes composite view set version 1 1018, composite view set 2 1020 and current composite view set 1022 System 1000 further includes map storage 1024, which includes map version 1 1026, map version 2 1028, and current map 1030.

In one exemplary embodiment, new files can be stored in file storage 1004 and versioned as new files are added such as file version 1 1006 and file version 2 1008. Views extracted from files are stored in view set storage 1010 and versioned as new views are extracted, such as view set version 1 1012 and view set version 2 1014. Composite view sets comprised of both new and previous views can be stored in the composite view set storage 1016. As new composite views are created and made current 1022, older composite view sets are archived, such as composite view set version 1 1018 and composite view set version 2 1020. Lastly maps are stored in map storage 1024. The current map 1030 can be derived from the current composite view set 1022. Older maps are archived such as map version 1 1026 and map version 2 1028 as new maps are created.

It should be emphasized. that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1-9. (canceled)

10. A computer-implemented method of selectively displaying layers of an electronic document, comprising:
determining, at one or more computer systems, a plurality of scale levels associated with an electronic document;
determining, at the one or more computer systems, a plurality of graphical layers, each graphical layer being associated with at least one of the plurality of scale levels;
determining, at the one or more computer systems, a current display scale level of the plurality of scale levels, the current display scale level being associated with a first level;
receiving, at the one or more computer systems, an indication to change the current display scale level from the first level to a second level;
associating, at the one or more computer systems, the current display scale level with the second level;
iteratively determining, at the one or more computer systems, a visibility state for each of the plurality of graphical layers based on the current display scale level; and
causing one or more layers of the plurality of graphical layers to be displayed on a display of the current display scale level of the electronic document based on the determination of the visibility state for each of the plurality of graphical layers.

11. The method of claim 10, further comprising:
determining a plurality of elements associated with the electronic document;
determining a class for each of the plurality of elements; and
causing one or more of the plurality of elements to be displayed on the display based on an association between the class and the current display scale level.

12. The method of claim 10, further comprising:
determining, at the one or more computer systems, a visibility state for each of the plurality of graphical layers;
upon determining that the visibility state of a layer of the plurality of graphical layers is not visible, causing the layer to not be displayed; and
upon determining that the visibility state of the layer of the plurality of graphical layers is visible, causing the layer to be displayed if the layer is associated with the current display level.

13. The method of claim 10, further comprising:
determining a plurality of elements associated with the electronic document;
determining a profession associated with each of the plurality of elements associated with the electronic document; and
causing one or more of the plurality of elements to be displayed on the display based on the current display scale level of the electronic document and the profession.

14. The method of claim 10, further comprising:
upon determining that the visibility state for a layer of the plurality of graphical layers for the current display scale level is non-visible, causing the layer to not be displayed on the display.

15. The method of claim 10, wherein the indication to change the current display scale level from the first level to the second level is received from a user.

16. The method of claim 10, further comprising:
upon determining that the visibility state of all of the plurality of graphical layers is non-visible, generating an error indication.

17. A system for selectively displaying layers of an electronic document, comprising:
at least one data storage device storing instructions for selectively displaying layers of an electronic document; and
at least one processor configured to execute the instructions to perform a method comprising:
determining, at the processor, a plurality of scale levels associated with an electronic document;
determining, at the processor, a plurality of graphical layers, each graphical layer being associated with at least one of the plurality of scale levels;
determining, at the processor, a current display scale level of the plurality of scale levels, the current display scale level being associated with a first level;
receiving, at the processor, an indication to change the current display scale level from the first level to a second level;
associating, at the processor, the current display scale level with the second level;
iteratively determining, at the processor, a visibility state for each of the plurality of graphical layers based on the current display scale level; and
causing one or more layers of the plurality of graphical layers to be displayed on a display of the current display scale level of the electronic document based on the determination of the visibility state for each of the plurality of graphical layers.

18. The system of claim 17, wherein the processor is further configured for:
determining a plurality of elements associated with the electronic document;
determining a class for each of the plurality of elements; and
causing one or more of the plurality of elements to be displayed on the display based on an association between the class and the current display scale level.

19. The system of claim 17, wherein the processor is further configured for:
determining, at the processor, a visibility state for each of the plurality of graphical layers;
upon determining that the visibility state of a layer of the plurality of graphical layers is not visible, causing the layer to not be displayed; and
upon determining that the visibility state of the layer of the plurality of graphical layers is visible, causing the layer to be displayed if the layer is associated with the current display level.

20. The system of claim 17, wherein the processor is further configured for:
determining a plurality of elements associated with the electronic document;
determining a profession associated with each of the plurality of elements associated with the electronic document; and
causing one or more of the plurality of elements to be displayed on the display based on the current display scale level of the electronic document and the profession.

21. The system of claim 17, wherein the processor is further configured for:
upon determining that the visibility state for a layer of the plurality of graphical layers for the current display scale level is non-visible, causing the layer to not be displayed on the display.

22. The system of claim 17, wherein the indication to change the current display scale level from the first level to the second level is received from a user.

23. The system of claim 17, wherein the processor is further configured for:
upon determining that the visibility state of all of the plurality of graphical layers is non-visible, generating an error indication.

24. A non-transitory computer-readable medium storing instructions that, when executed by a processor, cause the processor to perform a method of selectively displaying layers of an electronic document, the method comprising:
determining, at one or more computer systems, a plurality of scale levels associated with an electronic document;
determining, at the one or more computer systems, a plurality of graphical layers, each graphical layer being associated with at least one of the plurality of scale levels;
determining, at the one or more computer systems, a current display scale level of the plurality of scale levels, the current display scale level being associated with a first level;
receiving, at the one or more computer systems, an indication to change the current display scale level from the first level to a second level;
associating, at the one or more computer systems, the current display scale level with the second level;
iteratively determining, at the one or more computer systems, a visibility state for each of the plurality of graphical layers based on the current display scale level; and
causing one or more layers of the plurality of graphical layers to be displayed on a display of the current display scale level of the electronic document based on the determination of the visibility state for each of the plurality of graphical layers.

25. The non-transitory computer-readable medium of claim 24, wherein the processor is further configured for:
determining a plurality of elements associated with the electronic document;
determining a class for each of the plurality of elements; and
causing one or more of the plurality of elements to be displayed on the display based on an association between the class and the current display scale level.

26. The non-transitory computer-readable medium of claim 24, wherein the processor is further configured for:
determining, at the processor, a visibility state for each of the plurality of graphical layers;
upon determining that the visibility state of a layer of the plurality of graphical layers is not visible, causing the layer to not be displayed; and
upon determining that the visibility state of the layer of the plurality of graphical layers is visible, causing the layer to be displayed if the layer is associated with the current display level.

27. The non-transitory computer-readable medium of claim 24, wherein the processor is further configured for:
determining a plurality of elements associated with the electronic document;
determining a profession associated with each of the plurality of elements associated with the electronic document; and
causing one or more of the plurality of elements to be displayed on the display based on the current display scale level of the electronic document and the profession.

28. The non-transitory computer-readable medium of claim 24, wherein the processor is further configured for:
upon determining that the visibility state for a layer of the plurality of graphical layers for the current display scale level is non-visible, causing the layer to not be displayed on the display.

29. The non-transitory computer-readable medium of claim 24, wherein the processor is further configured for:
upon determining that the visibility state of all of the plurality of graphical layers is non-visible, generating an error indication.
